(19) United States
(12) Patent Application Publication
(10) Pub. No.: US 2012/0320015 A1
(43) Pub. Date: Dec. 20, 2012

(54) PLASMA DISPLAY DEVICE AND PLASMA DISPLAY SYSTEM

(76) Inventors: Yuya Shiozaki, Osaka (JP); Takahiko Origuchi, Osaka (JP); Mitsuhiro Ishizuka, Osaka (JP)

(21) Appl. No.: 13/582,015

(22) PCT Filed: Mar. 2, 2011
(86) PCT No.: PCT/JP2011/001204

§ 371 Date: Aug. 30, 2012

(30) Foreign Application Priority Data
Mar. 9, 2010 (JP) 2010-051379

(51) Int. Cl. G09G 5/00; G09G 3/28

(52) U.S. Cl. 345/207; 345/60

(57) ABSTRACT

In a plasma display apparatus usable as a 3D image display apparatus, crosstalk is reduced to the user who views a 3D image displayed on the plasma display panel through a pair of shutter glasses. For this purpose, in a plasma display system, in each of fields for the right eye and fields for the left eye, luminance weights are set such that the first subfield in the one field has the heaviest luminance weight and those thereafter have luminance weights sequentially decreasing. A pair of shutter glasses is controlled in the following manner. The right eye shutter opens before the sustain period of the subfield where an address operation is performed first in the field for the right eye. The left eye shutter opens before the sustain period of the subfield where an address operation is performed first in the field for the left eye.

### TECHNICAL FIELD

The present invention relates to a plasma display apparatus and a plasma display system that allow stereoscopic view of an image for the right eye and an image for the left eye alternately displayed on the plasma display panel, using a pair of shutter glasses.

### BACKGROUND ART

In an AC surface discharge panel, i.e. a typical plasma display panel (hereinafter, simply referred to as “panel”), a large number of discharge cells are formed between a front substrate and a rear substrate facing each other. With the front substrate, a plurality of display electrode pairs, each including a scan electrode and a sustain electrode, is formed in parallel with each other on a front glass substrate. A dielectric layer and a protective layer are formed so as to cover these display electrode pairs.

With the rear substrate, a plurality of parallel data electrodes is formed on a rear glass substrate. A dielectric layer is formed so as to cover these data electrodes. On the dielectric layer, a plurality of barrier ribs is formed in parallel with the data electrodes. Phosphor layers are formed on the surface of the dielectric layer and on the side faces of the barrier ribs.

The front substrate and the rear substrate are opposed to each other and sealed together such that the display electrode pairs three-dimensionally intersect the data electrodes. In the sealed inside discharge space, a discharge gas containing xenon at a partial pressure ratio of 5%, for example, is sealed, and discharge cells are formed in the parts where the display electrode pairs face the data electrodes. In the thus structured panel, a gas discharge generates ultraviolet rays in each discharge cell, and the ultraviolet rays excite the phosphors of red (R) color, green (G) color, and blue (B) color such that the phosphors of the respective colors emit light for color image display.

A typically used method for driving the panel is a subfield method. In the subfield method, gradations are displayed by dividing one field into a plurality of subfields and causing light emission or no light emission in each discharge cell in each subfield. Each of the subfields has an initializing period, an address period, and a sustain period.

In the initializing periods, initializing waveforms are applied to the respective scan electrodes so as to cause an initializing discharge in the respective discharge cells. This operation forms wall charge necessary for the subsequent address operation in the respective discharge cells, and generates priming particles (excitation particles for generating a discharge) for generating an address discharge stably.

In the address periods, a scan pulse is sequentially applied to the scan electrodes, and an address pulse is applied selectively to the data electrodes based on the signals of the image to be displayed. This operation causes an address discharge between the scan electrodes and the data electrodes in the discharge cells to be lit and forms wall charge in the discharge cells (hereinafter, these operations being also generically referred to as “addressing”).

In the sustain periods, a number of sustain pulses based on the luminance weight predetermined for each subfield are applied alternately to the display electrode pairs, each including a scan electrode and a sustain electrode. This operation causes a sustain discharge in the discharge cells having undergone the address discharge, and causes the phosphor layers of the discharge cells to emit light. (Hereinafter, causing a discharge cell to be lit by a sustain discharge is also referred to as “lighting”, and causing a discharge cell not to be lit as “non-lighting”.) Thus, the respective discharge cells are lit at luminances corresponding to the luminance weight. In this manner, the respective discharge cells of the panel are lit at luminances corresponding to the gradation values of the image signals for image display in the image display area of the panel.

Further, methods for displaying a three-dimensional (hereinafter, “3D”) image for stereoscopic view (hereinafter, “3D image”) on such a panel and for using a plasma display apparatus as a 3D image display apparatus are considered.

One 3D image is formed of one image for the right eye and one image for the left eye. When a 3D image is displayed on the panel of this plasma display apparatus, the image for the right eye and the image for the left eye are alternately displayed on the panel. The user views the 3D image displayed on the panel using special glasses called a pair of shutter glasses where the left eye shutter and the right eye shutter alternately open and close in synchronization with a field for display of an image for the right eye and a field for display of an image for the left eye (see Patent Literature 1, for example).

The pair of shutter glasses includes the shutter for the right eye and the shutter for the left eye. In the period during which an image for the right eye is displayed on the panel, the right eye shutter is opened (in a state of transmitting visible light) and the left eye shutter is closed (in a state of blocking visible light). In the period during which an image for the left eye is displayed, the left eye shutter is opened and the right eye shutter is closed. This operation enables the user to view the image for the right eye only with the right eye, and the image for the left eye only with the left eye. Thus, the user can stereoscopically view the 3D image displayed on the panel.

However, the phosphors used in the panel have a long afterglow time. There is a phosphor material that has a characteristic of persistence of afterglow for several milliseconds after a sustain discharge has been completed. The afterglow is a phenomenon such that the light emission continues even after the discharge in a discharge cell has been completed. The afterglow time is a time taken until the afterglow sufficiently decreases.

Therefore, for example, even after the period for display of an image for the right eye has been completed, the image for the right eye is displayed on the panel as an afterimage for a short while in some cases. The afterimage is a phenomenon such that an image is displayed on the panel by the afterglow even after the display period of the image has been completed.

When an image for the left eye is displayed on the panel before the afterimage of an image for the right eye disappears, the phenomenon of entry of the image for the right eye into the image for the left eye occurs. Similarly, when an image for the right eye is displayed on the panel before the afterimage of an image for the left eye disappears, the phenomenon of entry of the image for the left eye into the image for the right eye occurs. Hereinafter, such a phenomenon is referred to as “crosstalk”. Occurrence of crosstalk makes stereoscopic view difficult.

### CITATION LIST

### Patent Literature

PTL1

Japanese Patent Unexamined Publication No. 2000-112428

### SUMMARY OF THE INVENTION

A plasma display system of the present invention includes the following elements:

a plasma display apparatus including the following elements:
a panel having a plurality of discharge cells arranged therein; and
a driver circuit for driving the panel, the driver circuit displaying an image on the panel by alternately repeating a field for the right eye and a field for the left eye, an image signal for the right eye being displayed in the field for the right eye, an image signal for the left eye being displayed in the field for the left eye; and
a pair of shutter glasses including a right eye shutter for opening and closing in the field for the right eye, and a left eye shutter for opening and closing in the field for the left eye.
   In the plasma display apparatus, each of the field for the right eye and the field for the left eye is formed of a plurality of subfields, and each of the subfields has a predetermined luminance weight. The luminance weights of the respective subfields are set such that the first subfield of the one field has the largest luminance weight, and the subfields thereafter have luminance weights sequentially decreasing. The pair of shutter glasses is controlled in the following manner. The right eye shutter opens before the sustain period of the subfield where an address operation is performed first in the field for the right eye, and closes before the field for the left eye next to the field for the right eye. The left eye shutter opens before the sustain period of the subfield where an address operation is performed first in the field for the left eye, and closes before the field for the right eye next to the field for the left eye.

This control can enhance the image display quality by reducing crosstalk to the user who views a 3D image displayed on the panel through a pair of shutter glasses in a plasma display apparatus usable as a 3D image display apparatus.

A plasma display system of the present invention includes the following elements:

a plasma display apparatus including the following elements:
a panel having a plurality of discharge cells arranged therein; and
a driver circuit for driving the panel, the driver circuit displaying an image on the panel by alternately repeating a field for the right eye and a field for the left eye, an image signal for the right eye being displayed in the field for the right eye, an image signal for the left eye being displayed in the field for the left eye; and

a pair of shutter glasses including a right eye shutter for opening and closing in the field for the right eye, and a left eye shutter for opening and closing in the field for the left eye.

In the plasma display apparatus, each of the field for the right eye and the field for the left eye is formed of a plurality of subfields, and each of the subfields has a predetermined luminance weight. The luminance weights of the respective subfields are set such that the first subfield of the one field has the largest luminance weight, and the subfields thereafter have luminance weights sequentially decreasing. The pair of shutter glasses is controlled in the following manner. When the right eye shutter opens in the field for the right eye and an address operation is performed in the first subfield of the one field, the right eye shutter opens before the sustain period of the first subfield. When the right eye shutter opens in the field for the right eye and an address operation is not performed in the first subfield of the one field, the right eye shutter opens before the sustain period of the subfield next to the first subfield. When the right eye shutter closes, the right eye shutter closes before the field for the left eye next to the field for the right eye. When the left eye shutter opens in the field for the left eye and an address operation is performed in the first subfield of the one field, the left eye shutter opens before the sustain period of the first subfield. When the left eye shutter opens in the field for the left eye and an address operation is not performed in the first subfield of the one field, the left eye shutter opens before the sustain period of the subfield next to the first subfield. When the left eye shutter closes, the left eye shutter closes before the field for the right eye next to the field for the left eye.

This control can enhance the image display quality by reducing crosstalk to the user who views a 3D image displayed on the panel through a pair of shutter glasses in a plasma display apparatus usable as a 3D image display apparatus.

A plasma display apparatus of the present invention includes the following elements:

a panel having a plurality of discharge cells arranged therein; and

a driver circuit for driving the panel, the driver circuit displaying an image on the panel by alternately repeating a field for the right eye and a field for the left eye, an image signal for the right eye being displayed in the field for the right eye, an image signal for the left eye being displayed in the field for the left eye.

The driver circuit sets such that each of the field for the right eye and the field for the left eye is formed of a plurality of subfields, and each of the subfields has a predetermined luminance weight. The luminance weights of the respective subfields are set such that the first subfield of the one field has the largest luminance weight, and the subfields thereafter have luminance weights sequentially decreasing. The driver circuit generates a control signal to a pair of shutter glasses including a right eye shutter and a left eye shutter in the following manner. The right eye shutter opens before the sustain period of the subfield where an address operation is performed first in the field for the right eye, and closes before the field for the left eye next to the field for the right eye. The left eye shutter opens before the sustain period of the subfield where an address operation is performed first in the field for the left eye, and closes before the field for the right eye next to the field for the left eye.

This operation can enhance the image display quality by reducing crosstalk to the user who views a 3D image displayed on the panel through a pair of shutter glasses in a plasma display apparatus usable as a 3D image display apparatus.

A plasma display apparatus of the present invention includes the following elements:

a panel having a plurality of discharge cells arranged therein; and

a driver circuit for driving the panel, the driver circuit displaying an image on the panel by alternately repeating a field for the right eye and a field for the left eye, an image signal for the right eye being displayed in the field for the right eye, an image signal for the left eye being displayed in the field for the left eye.

In the driver circuit, each of the field for the right eye and the field for the left eye is formed of a plurality of subfields, and each of the subfields has a predetermined luminance weight. The luminance weights of the respective subfields are set such that the first subfield of the one field has the largest luminance weight, and the subfields thereafter have luminance weights sequentially decreasing. The driver circuit generates a control signal to a pair of shutter glasses including a right eye shutter and a left eye shutter in the following manner. When the right eye shutter opens in the field for the right eye and an address operation is performed in the first subfield of the one field, the right eye shutter opens before the sustain period of the first subfield. When the right eye shutter opens in the field for the right eye and an address operation is not performed in the first subfield of the one field, the right eye shutter opens before the sustain period of the subfield next to the first subfield. When the right eye shutter closes, the right eye shutter closes before the field for the left eye next to the field for the right eye. When the left eye shutter opens in the field for the left eye and an address operation is performed in the first subfield of the one field, the left eye shutter opens before the sustain period of the first subfield. When the left eye shutter opens in the field for the left eye and an address operation is not performed in the first subfield of the one field, the left eye shutter opens before the sustain period of the subfield next to the first subfield. When the left eye shutter closes, the left eye shutter closes before the field for the right eye next to the field for the left eye.

This operation can enhance the image display quality by reducing crosstalk to the user who views a 3D image displayed on the panel through a pair of shutter glasses in a plasma display apparatus usable as a 3D image display apparatus.

### BRIEF DESCRIPTION OF DRAWINGS

FIG. 1 is an exploded perspective view showing a structure of a panel for use in a plasma display apparatus in accordance with a first exemplary embodiment of the present invention.

FIG. 2 is an electrode array diagram of the panel for use in the plasma display apparatus in accordance with the first exemplary embodiment.

FIG. 3 is a diagram schematically showing a circuit block of the plasma display apparatus and a plasma display system in accordance with the first exemplary embodiment.

FIG. 4 is a chart schematically showing driving voltage waveforms applied to respective electrodes of the panel for use in the plasma display apparatus in accordance with the first exemplary embodiment.

FIG. 5 is a diagram schematically showing a subfield structure in the plasma display apparatus, and an example of opening/closing control of a pair of shutter glasses in accordance with the first exemplary embodiment.

FIG. 6 is a graph schematically showing an intensity of afterglow in a target field when a sustain discharge is caused in a field immediately preceding the target field.

FIG. 7 is a diagram schematically showing a subfield structure in the plasma display apparatus, and an example of opening/closing control of a pair of shutter glasses in accordance with a second exemplary embodiment of the present invention.

### DESCRIPTION OF EMBODIMENTS

Hereinafter, a plasma display apparatus and a plasma display system in accordance with exemplary embodiments of the present invention are described with reference to the accompanying drawings.

### First Exemplary Embodiment

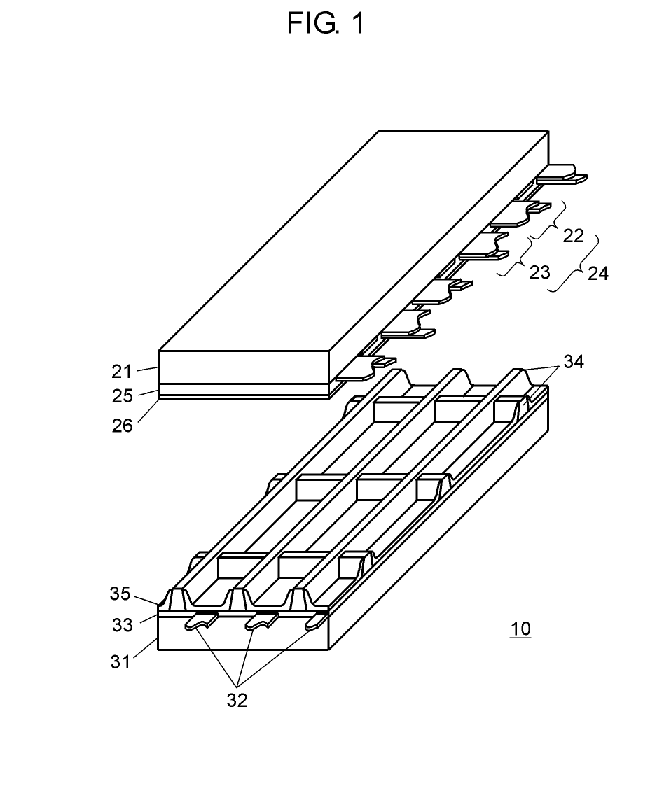

FIG. 1 is an exploded perspective view showing a structure of panel 10 for use in a plasma display apparatus in accordance with the first exemplary embodiment of the present invention. A plurality of display electrode pairs 24, each including scan electrode 22 and sustain electrode 23, is disposed on glass front substrate 21. Dielectric layer 25 is formed so as to cover scan electrodes 22 and sustain electrodes 23. Protective layer 26 is formed over dielectric layer 25.

In order to lower a discharge start voltage in the discharge cells, protective layer 26 is formed of a material predominantly composed of magnesium oxide (MgO). MgO has proven performance as a panel material, and has a large secondary electron emission coefficient and excellent durability when neon (Ne)-xenon (Xe) gas is sealed.

A plurality of data electrodes 32 is formed on rear substrate 31. Dielectric layer 33 is formed so as to cover data electrodes 32, and mesh barrier ribs 34 are formed on the dielectric layer. On the side faces of barrier ribs 34 and on dielectric layer 33, phosphor layers 35 for emitting light of red (R) color, green (G) color, and blue (B) color are formed.

Front substrate 21 and rear substrate 31 face each other such that display electrode pairs 24 intersect data electrodes 32 with a small discharge space sandwiched between the electrodes. The outer peripheries of the substrates are sealed with a sealing material, such as a glass frit. In the inside discharge space, a neon-xenon mixture gas, for example, is sealed as a discharge gas.

The discharge space is partitioned into a plurality of compartments by barrier ribs 34. Discharge cells are formed in the intersecting parts of display electrode pairs 24 and data electrodes 32.

These discharge cells cause discharge and the discharge causes phosphor layers 35 of the discharge cells to emit light (lights the discharge cells), so that a color image is displayed on panel 10.

In panel 10, three consecutive discharge cells arranged in the extending direction of display electrode pair 24, i.e. a discharge cell for emitting light of red (R) color, a discharge cell for emitting light of green (G) color, and a discharge cell for emitting light of blue (B) color, form one pixel.

The structure of panel 10 is not limited to the above, and may include barrier ribs in a stripe pattern, for example.

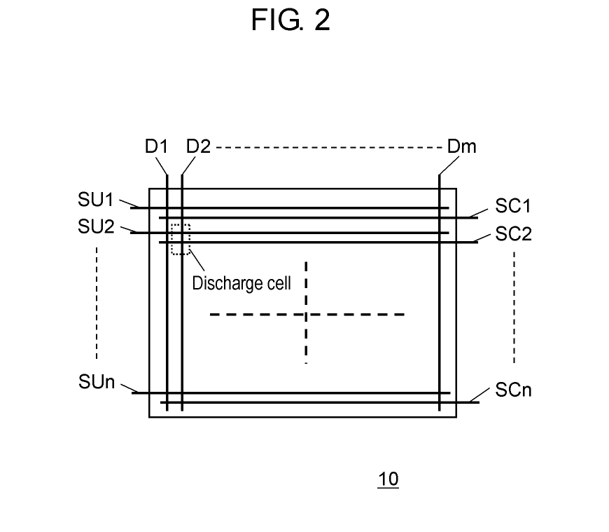

FIG. 2 is an electrode array diagram of panel 10 for use in the plasma display apparatus in accordance with the first exemplary embodiment of the present invention. Panel 10 has n scan electrode SC1-scan electrode SCn (scan electrodes 22 in FIG. 1) and n sustain electrode SU1-sustain electrode SUn (sustain electrodes 23 in FIG. 1) both extending in the horizontal direction (line direction), and m data electrode D1-data electrode Dm (data electrodes 32 in FIG. 1) extending in the vertical (column) direction. A discharge cell is formed in the part where a pair of scan electrode SCi (i=1-n) and sustain electrode SUi intersects one data electrode Dj (j=1-m). That is, one display electrode pair 24 has m discharge cells, which form m/3 pixels. Then, m×n discharge cells are formed in the discharge space, and the area having m×n discharge cells is the image display area of panel 10. For example, in a panel having 1920×1080 pixels, m=1920×3 and n=1080.

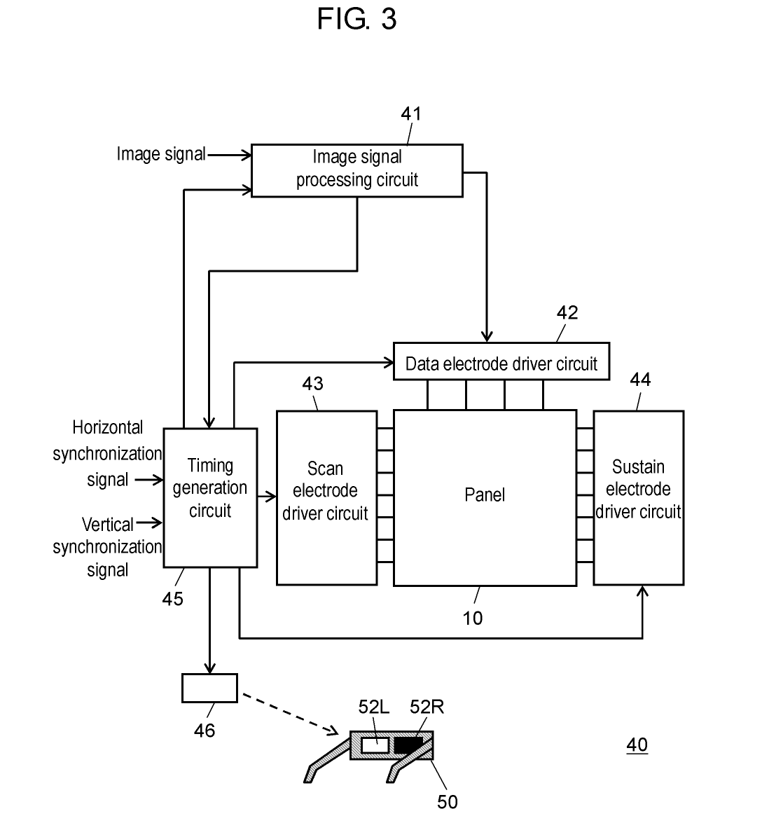

FIG. 3 is a diagram schematically showing a circuit block of plasma display apparatus 40 and a plasma display system in accordance with the first exemplary embodiment of the present invention. The plasma display system of this exemplary embodiment includes plasma display apparatus 40 and pair of shutter glasses 50 as the elements.

Plasma display apparatus 40 has panel 10 and a driver circuit for driving panel 10. The driver circuit has image signal processing circuit 41; data electrode driver circuit 42; scan electrode driver circuit 43; sustain electrode driver circuit 44; timing generation circuit 45; control signal output part 46; and electric power supply circuits (not shown) for supplying electric power necessary for each circuit block.

Image signal processing circuit 41 allocates a gradation value to each discharge cell, based on the input image signal. The image signal processing circuit converts the gradation value into image data representing light emission and no light emission (data where light emission and no light emission correspond to digital signals “1” and “0”, respectively) in each subfield. That is, image signal processing circuit 41 converts the image signals in each field into image data representing light emission and no light emission in each subfield.

When the input image signal includes an R signal, a G signal, and a B signal, the image signal processing circuit allocates the R, G, and B gradation values to the respective discharge cells, based on the R signal, the G signal, and the B signal. When the input image signal includes a luminance signal (Y signal) and a chroma signal (C signal, R-Y signal and B-Y signal, u signal and v signal, or the like), the R signal, the G signal, and the B signal are calculated based on the luminance signal and the chroma signal, and thereafter the R, G, and B gradation values (gradation values represented in one field) are allocated to the respective discharge cells. Then, the R, G, and B gradation values allocated to the respective discharge cells are converted into image data representing light emission and no light emission in each subfield.

When the input image signal is a 3D image signal for stereoscopic view that includes an image signal for the right eye and an image signal for the left eye and the 3D image signal is displayed on panel 10, the image signal for the right eye and the image signal for the left eye are input into image signal processing circuit 41 alternately in each field. Thus, image signal processing circuit 41 converts the image signal for the right eye into image data for the right eye, and the image signal for the left eye into image data for the left eye.

Based on a horizontal synchronization signal and vertical synchronization signal, timing generation circuit 45 generates various timing signals for controlling the operation of each circuit block. Then, the timing generation circuit supplies the generated timing signals to each circuit block (data electrode driver circuit 42, scan electrode driver circuit 43, sustain electrode driver circuit 44, image signal processing circuit 41, or the like).

Timing generation circuit 45 outputs a shutter control signal for controlling the opening/closing of the shutters of pair of shutter glasses 50, to control signal output part 46. Timing generation circuit 45 sets the shutter control signal to ON (“1”) when the shutter of pair of shutter glasses 50 is opened (in a state of transmitting visible light). The timing generation circuit sets the shutter control signal to OFF (“0”) when the shutter of pair of shutter glasses 50 is closed (in a state of blocking visible light). The shutter control signal has the following two types: a control signal (a control signal for the right eye shutter) that is set to ON when a field for the right eye for display of an image signal for the right eye is displayed on panel 10, and is set to OFF when a field for the left eye for display of an image signal for the left eye is displayed on panel 10; and a control signal (a control signal for the left eye shutter) that is set to ON when a field for the left eye for display of an image signal for the left eye is displayed on panel 10, and is set to OFF when a field for the right eye for display of an image signal for the right eye is displayed on panel 10.

Scan electrode driver circuit 43 has an initializing waveform generation circuit, a sustain pulse generation circuit, and a scan pulse generation circuit (not shown in FIG. 3). The scan electrode driver circuit generates driving voltage waveforms, based on the timing signals supplied from timing generation circuit 45, and applies the waveforms to each of scan electrode SC1-scan electrode SCn. Based on the timing signal, the initializing waveform generation circuit generates an initializing waveform to be applied to scan electrode SC1-scan electrode SCn in the initializing periods. Based on the timing signal, the sustain pulse generation circuit generates a sustain pulse to be applied to scan electrode SC1-scan electrode SCn in the sustain periods. The scan pulse generation circuit has a plurality of scan electrode driver ICs (scan ICs). Based on the timing signal, the scan pulse generation circuit generates a scan pulse to be applied to scan electrode SC1-scan electrode SCn in the address periods.

Sustain electrode driver circuit 44 has a sustain pulse generation circuit and a circuit for generating voltage Ve1 and voltage Ve2 (not shown in FIG. 3), generates a driving voltage waveform based on the timing signal supplied from timing generation circuit 45, and applies the driving voltage waveform to each of sustain electrode SU1-sustain electrode SUn. In the sustain periods, based on the timing signal, sustain pulses are generated and applied to sustain electrode SU1-sustain electrode SUn.

Data electrode driver circuit 42 converts data in each subfield into a signal corresponding to each of data electrode D1-data electrode Dm. The above data forms image data including image data for the right eye and image data for the left eye. Then, based on the above signal, and the timing signal supplied from timing generation circuit 45, the data electrode driver circuit drives each of data electrode D1-data electrode Dm. In the address periods, the data electrode driver circuit generates an address pulse and applies the address pulse to each of data electrode D1-data electrode Dm.

Control signal output part 46 includes a light-emitting element, such as a light-emitting diode (LED). The control signal output part supplies shutter control signals to pair of shutter glasses 50, as those converted into infrared signals, for example. The shutter control signal is a signal for controlling the opening/closing of the shutters of pair of shutter glasses 50 to be used by the user in synchronization with fields for the right eye and fields for the left eye. Specifically; control signal output part 46 converts the shutter control signal into a serial signal that includes a code part for discriminating “right eye shutter”, “left eye shutter”, “opening”, “closing”, or the like, and a timing part showing the switching timing of the shutters. This serial signal is a shutter control signal. This serial signal is converted into an infrared light signal, using a light-emitting element, such as an LED, and supplied to pair of shutter glasses 50.

Pair of shutter glasses 50 has a control signal receiver part (not shown) for receiving the light signal output from control signal output part 46, right eye shutter 52R, and left eye shutter 52L. Right eye shutter 52R and left eye shutter 52L open and close independently. Pair of shutter glasses 50 demodulates the light signal output from control signal output part 46 into a shutter control signal, and right eye shutter 52R and left eye shutter 52L open and close in response to the shutter control signal. Right eye shutter 52R opens (transmits visible light) when the shutter control signal for the right eye is set to ON, and closes (blocks visible light) when that control signal is set to OFF. Left eye shutter 52L opens (transmits visible light) when the shutter control signal for the left eye is set to ON, and closes (blocks visible light) when that control signal is set to OFF. Right eye shutter 52R and left eye shutter 52L can be formed of liquid crystal, for example. However, in the present invention, the materials making up the shutters are not limited to liquid crystal. As long as blocking and transmission of visible light can be switched at a high speed, any material may be used.

Next, driving voltage waveforms for driving panel 10 and the operation thereof are described. Plasma display apparatus 40 of this exemplary embodiment displays gradations by a subfield method. In the subfield method, one field is divided into a plurality of subfields along a temporal axis, and a luminance weight is set for each subfield. Each of the subfields has an initializing period, an address period, and a sustain period. An image is displayed on panel 10 by controlling the light emission and no light emission in each discharge cell in each subfield.

The luminance weight represents a ratio of the magnitudes of luminance displayed in each subfield. In the sustain period of each subfield, sustain pulses corresponding in number to the luminance weight are generated. Thus, for example, the luminance of the light emission in the subfield having the luminance weight “8” is approximately eight times as high as that in the subfield having the luminance weight “1”, and is approximately four times as high as that in the subfield having the luminance weight “2”. Thus, various gradations and an image can be displayed by selectively causing light emission in each subfield in combination in response to image signals.

In this exemplary embodiment, the image signal input into plasma display apparatus 40 is an image signal for stereoscopic view where an image signal for the right eye and an image signal for the left eye are repeated alternately in each field. An image for stereoscopic view (a 3D image) made of an image for the right eye and an image for the left eye is displayed on panel 10 by alternately repeating a field for the right eye and a field for the left eye. In the field for the right eye, an image signal for the right eye is displayed. In the field for the left eye, an image signal for the left eye is displayed.

Thus, the number of 3D images displayed per unit time (e.g. one second) is a half the field frequency (the number of fields generated per second). For instance, when the field frequency is 60 Hz, 30 images for the right eye and 30 images for the left eye are displayed per second. Thus, thirty 3D images are displayed per second. Then, in this exemplary embodiment, the field frequency is set to twice (e.g. 120 Hz) the general field frequency, and flickering (flickers) likely to occur in display of images having a low field frequency is reduced.

The user views a 3D image displayed on panel 10 through pair of shutter glasses 50 where right eye shutter 52R and left eye shutter 52L open and close independently in synchronization with the field for the right eye and the field for the left eye, respectively With this operation, the user can view an image for the right eye only with the right eye and an image for the left eye only with the left eye, thereby stereoscopically viewing the 3D image displayed on panel 10.

In the field for the right eye and the field for the left eye, only the signals of the images to be displayed are different. The structures of these fields, e.g. the number of subfields forming one field, the luminance weights of the respective subfields, and the arrangement of the subfields, are identical with each other. Hereinafter, when a field “for the right eye” and a field “for the left eye” do not need to be discriminated, each of the field for the right eye and the field for the left eye is simply referred to as a field. Each of an image signal for the right eye and an image signal for the left eye is also simply referred to as an image signal. The structure of the field is also referred to as a subfield structure.

First, a description is provided for the structure of one field, and the driving voltage waveforms to be applied to the respective electrodes. Each of the field for the right eye and the field for the left eye has a plurality of subfields. Each of the subfields has an initializing period, an address period, and a sustain period.

In the initializing periods, an initializing operation is performed so as to cause an initializing discharge in the discharge cells and form wall charge necessary for the address discharge in the subsequent address period on the respective electrodes. The initializing operation includes the following two types: a forced initializing operation for causing an initializing discharge in the discharge cells regardless of the operation in the immediately preceding subfield; and a selective initializing operation for causing an initializing discharge only in the discharge cells having undergone an address discharge in the address period of the immediately preceding subfield.

In the address periods, an address operation is performed in the following manner. A scan pulse is applied to scan electrodes 22 and an address pulse is applied selectively to data electrodes 32 so as to cause an address discharge selectively in the discharge cells to be lit and form wall charge for causing a sustain discharge in the subsequent sustain period in the discharge cells.

In the sustain periods, a sustain operation is performed in the following manner. Sustain pulses corresponding in number to the luminance weight set for each subfield multiplied by a predetermined proportionality factor are applied alternately to scan electrodes 22 and sustain electrodes 23. Thereby, a sustain discharge is caused for light emission in the discharge cells having undergone an address discharge in the immediately preceding address period. This proportionality factor is a luminance magnification. For example, when the luminance magnification is 2, in the sustain period of a subfield having the luminance weight “2”, four sustain pulses are applied to each of scan electrodes 22 and sustain electrodes 23. Thus, the number of sustain pulses generated in the sustain period is 8.

In this exemplary embodiment, a description is provided for an example where one field is formed of five subfields (subfield SF1, subfield SF2, . . . subfield SF5).

Subfield SF1-subfield SF5 have respective luminance weights of 16, 8, 4, 2 and 1. That is, in this exemplary embodiment, luminance weights of the respective subfields are set in the following manner. Subfield SF1 generated first in a field is the subfield having the heaviest luminance weight, subfields generated thereafter have luminance weights sequentially decreasing, and subfield SF5 generated last in the field is the subfield having the lightest luminance weight.

In this exemplary embodiment, in the initializing period of subfield SF1 generated first in a field, a forced initializing operation for causing an initializing discharge in the discharge cells regardless of the operation in the immediately preceding subfield is performed. In the initializing periods of subfield SF2-subfield SF5, a selective initializing operation for causing an initializing discharge only in the discharge cells having undergone an address discharge in the immediately preceding subfields is performed. With this structure, the light emission unrelated to image display is only a light emission caused by the discharge in the forced initializing operation in subfield SF1. Therefore, the luminance of black level, i.e. the luminance of black display area where no sustain discharge occurs, is caused only by the weak light emission in the forced initializing operation. Thus, an image of high contrast can be displayed on panel 10.

However, in this exemplary embodiment, the number of subfields forming one field, and the luminance weights of the respective subfields are not limited to the above values. The subfield structure may be switched based on an image signal, for example.

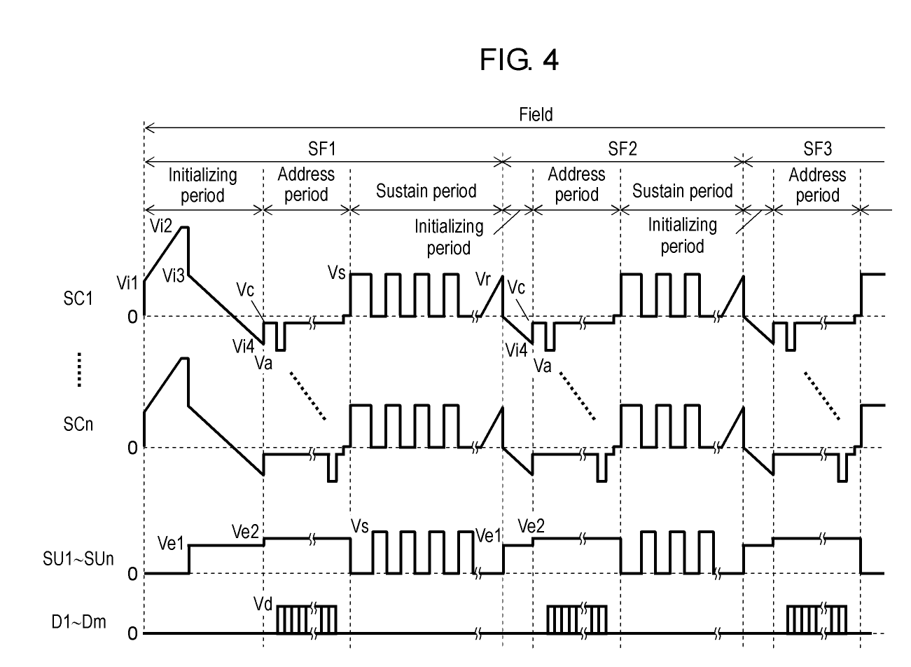

FIG. 4 is a chart showing driving voltage waveforms applied to respective electrodes of panel 10 for use in the plasma display apparatus in accordance with the first exemplary embodiment of the present invention. FIG. 4 shows driving voltage waveforms applied to the following electrodes: scan electrode SC1 for undergoing an address operation first in the address periods; scan electrode SCn for undergoing an address operation last in the address periods; sustain electrode SU1-sustain electrode SUn; and data electrode D1-data electrode Dm.

FIG. 4 mainly shows driving voltage waveforms in subfield SF1 and subfield SF2. Subfield SF1 is a subfield where a forced initializing operation is performed. Subfield SF2 through subfield SF5 are subfields where a selective initializing operation is performed. Therefore, between subfield SF1, and subfield SF2 through subfield SF5, the waveform shapes of the driving voltage applied to scan electrodes 22 in the initializing periods are different.

The driving voltage waveforms in subfield SF3 through subfield SF5 are substantially similar to those in subfield SF2 except for the number of sustain pulses in the sustain period. Scan electrode SCi, sustain electrode SUi, and data electrode Dk in the following description are the electrodes selected from the respective electrodes, based on image data (data representing light emission and no light emission in each subfield).

First, subfield SF1 is described.

In the first half of the initializing period of subfield SF1, where a forced initializing operation is performed, voltage 0 (V) is applied to each of data electrode D1-data electrode Dm and sustain electrode SU1-sustain electrode SUn. Voltage Vi1 and a ramp waveform voltage gently rising from voltage Vi1 toward voltage Vi2 are applied to scan electrode SC1-scan electrode SCn. Voltage Vi1 is set to a voltage lower than the discharge start voltage with respect to sustain electrode SU1-sustain electrode SUn. Voltage Vi2 is set to a voltage exceeding the discharge start voltage.

While this ramp waveform voltage is rising, a weak initializing discharge continuously occurs between scan electrode SC1-scan electrode SCn and sustain electrode SU1-sustain electrode SUn, and between scan electrode SC1-scan electrode SCn and data electrode D1-data electrode Dm. Then, negative wall voltage accumulates on scan electrode SC1-scan electrode SCn, and positive wall voltage accumulates on data electrode D1-data electrode Dm and sustain electrode SU1-sustain electrode SUn. This wall voltage on the electrodes means voltages that are generated by the wall charge accumulated on the dielectric layers covering the electrodes, the protective layer, the phosphor layers, or the like.

In the second half of the initializing period of subfield SF1, positive voltage Ve1 is applied to sustain electrode SU1-sustain electrode SUn and voltage 0 (V) is applied to data electrode D1-data electrode Dm. A ramp waveform voltage gently falling from voltage Vi3 toward negative voltage Vi4 is applied to scan electrode SC1-scan electrode SCn. Voltage Vi3 is set to a voltage lower than the discharge start voltage, and voltage Vi4 is set to a voltage exceeding the discharge start voltage with respect to sustain electrode SU1-sustain electrode SUn.

While this ramp waveform voltage is applied to scan electrode SC1-scan electrode SCn, a weak initializing discharge occurs between scan electrode SC1-scan electrode SCn and sustain electrode SU1-sustain electrode SUn, and between scan electrode SC1-scan electrode SCn and data electrode D1-data electrode Dm. This weak discharge reduces the negative wall voltage on scan electrode SC1-scan electrode SCn and the positive wall voltage on sustain electrode SU1-sustain electrode SUn, and adjusts the positive wall voltage on data electrode D1-data electrode Dm to a value suitable for the address operation.

In this manner, the initializing operation in the initializing period of subfield SF1, i.e. the forced initializing operation for forcedly causing an initializing discharge in all the discharge cells, is completed.

In the subsequent address period of subfield SF1, voltage Ve2 is applied to each of sustain electrode SU1-sustain electrode SUn, and voltage Vc is applied to each of scan electrode SC1-scan electrode SCn.

Next, a negative scan pulse at negative voltage Va is applied to scan electrode SC1 in the first line, which undergoes the address operation first. Further, a positive address pulse at positive voltage Vd is applied to data electrode Dk of a discharge cell to be lit in the first line among data electrode D1-data electrode Dm.

The voltage difference in the intersecting part of data electrode Dk and scan electrode SC1 in the discharge cell applied with the address pulse at voltage Vd is obtained by adding the difference between the wall voltage on data electrode Dk and the wall voltage on scan electrode SC1 to a difference in externally applied voltage (voltage Vd−voltage Va). Thus, the voltage difference between data electrode Dk and scan electrode SC1 exceeds the discharge start voltage, and a discharge occurs between data electrode Dk and scan electrode SC1.

Since voltage Ve2 is applied to sustain electrode SU1-sustain electrode SUn, the voltage difference between sustain electrode SU1 and scan electrode SC1 is obtained by adding the difference between the wall voltage on sustain electrode SU1 and the wall voltage on scan electrode SC1 to a difference in externally applied voltage (voltage Ve2−voltage Va). At this time, setting voltage Ve2 to a voltage value slightly lower than the discharge start voltage can make the state where a discharge is likely to occur but does not actually occurs between sustain electrode SU1 and scan electrode SC1.

With this setting, a discharge caused between data electrode Dk and scan electrode SC1 can trigger a discharge between the areas of sustain electrode SU1 and scan electrode SC1 intersecting data electrode Dk. Thus, an address discharge occurs in the discharge cell to be lit. Positive wall voltage accumulates on scan electrode SC1, and negative wall voltage accumulates on sustain electrode SU1. Negative wall voltage also accumulates on data electrode Dk.

In this manner, an address operation is performed so as to cause an address discharge in the discharge cells to be lit in the first line and accumulate wall voltage on the respective electrodes. In contrast, the voltage in the intersecting parts of scan electrode SC1 and data electrodes 32 applied with no address pulse does not exceed the discharge start voltage, and thus no address discharge occurs.

The above address operation is sequentially performed on scan electrode SC2, scan electrode SC3 . . . scan electrode SCn in this order until the operation reaches the discharge cells in the n-th line. Thus, the address period of subfield SF1 is completed. In this manner, in the address period, an address discharge is caused selectively in the discharge cells to be lit so as to form wall charge in the discharge cells.

In the subsequent sustain period of subfield SF1, first, voltage 0 (V) is applied to sustain electrode SU1-sustain electrode SUn, and a sustain pulse at positive voltage Vs is applied to scan electrode SC1-scan electrode SCn. In the discharge cells having undergone an address discharge, the voltage difference between scan electrode SCi and sustain electrode SUi is obtained by adding the difference between the wall voltage on scan electrode SCi and the wall voltage on sustain electrode SUi to sustain pulse voltage Vs.

Thus, the voltage difference between scan electrode SCi and sustain electrode SUi exceeds the discharge start voltage, and a sustain discharge occurs between scan electrode SCi and sustain electrode SUi. Ultraviolet rays generated by this discharge cause phosphor layers 35 to emit light. With this discharge, negative wall voltage accumulates on scan electrode SCi, and positive wall voltage accumulates on sustain electrode SUi. Positive wall voltage also accumulates on data electrode Dk. In the discharge cells having undergone no address discharge in the address period, no sustain discharge occurs and thus the wall voltage at the completion of the initializing period is maintained.

Subsequently, voltage 0 (V) is applied to scan electrode SC1-scan electrode SCn, and a sustain pulse at voltage Vs is applied to sustain electrode SU1-sustain electrode SUn. In the discharge cells having undergone the sustain discharge, the voltage difference between sustain electrode SUi and scan electrode SCi exceeds the discharge start voltage. Thereby, a sustain discharge occurs between sustain electrode SUi and scan electrode SCi again. Negative wall voltage accumulates on sustain electrode SUi, and positive wall voltage accumulates on scan electrode SCi.

Similarly, sustain pulses corresponding in number to the luminance weight multiplied by a predetermined luminance magnification are applied alternately to scan electrode SC1-scan electrode SCn and sustain electrode SU1-sustain electrode SUn. By giving an electric potential difference between the electrodes of each display electrode pair 24 in this manner, the sustain discharge is continued in the discharge cells having undergone the address discharge in the address period.

After the sustain pulses have been generated in the sustain period (at the end of the sustain period), a ramp waveform voltage that gently rises from voltage 0 (V) as a base electric potential toward voltage Vr is applied to scan electrode SC1-scan electrode SCn while voltage 0 (V) is applied to sustain electrode SUI-sustain electrode SUn and data electrode D1-data electrode Dm.

While the ramp waveform voltage applied to scan electrode SC1-scan electrode SCn is rising higher than the discharge start voltage, a weak discharge continuously occurs in the discharge cells having undergone a sustain discharge. The charged particles generated by this weak discharge accumulate on sustain electrode SUi and scan electrode SCi as wall charge so as to reduce the voltage difference between sustain electrode SUi and scan electrode SCi. This reduces the wall voltage on scan electrode SCi and the wall voltage on sustain electrode SUi while the positive wall voltage on data electrode Dk is left.

After the voltage applied to scan electrode SC1-scan electrode SCn has reached voltage Vr, the voltage applied to scan electrode SC1-scan electrode SCn is lowered to voltage 0 (V). Thus, the sustain operation in the sustain period of subfield SF1 is completed.

In this manner, subfield SF1 is completed.

In the initializing period of subfield SF2, where a selective initializing operation is performed, a selective initializing operation is performed so as to apply, to the respective electrodes, driving voltage waveforms where those in the first half of the initializing period of subfield SF1 are omitted. In the initializing period of subfield SF2, voltage Ve1 is applied to sustain electrode SU1-sustain electrode SUn and voltage 0 (V) is applied to data electrode D1-data electrode Dm. A ramp waveform voltage that gently falls from a voltage (e.g. voltage 0 (V)) lower than the discharge start voltage toward negative voltage Vi4 is applied to scan electrode SC1-scan electrode SCn. Voltage Vi4 is set to a voltage exceeding the discharge start voltage with respect to sustain electrode SU1-sustain electrode SUn.

While this ramp waveform voltage is applied to scan electrode SC1-scan electrode SCn, a weak initializing discharge occurs in the discharge cells having undergone a sustain discharge in the sustain period of the immediately preceding subfield (subfield SF1 in FIG. 4). This initializing discharge reduces the wall voltage on scan electrode SCi and sustain electrode SUi. Since sufficient positive wall voltage is accumulated on data electrode Dk by the sustain discharge caused in the sustain period of the immediately preceding subfield, the excess part of this wall voltage is discharged and the wall voltage on data electrode Dk is adjusted to a value suitable for the address operation.

In contrast, in the discharge cells having undergone no sustain discharge in the sustain period of the immediately preceding subfield (subfield SF1), no initializing discharge occurs, and the wall voltage having been generated is maintained.

In this manner, the initializing operation in subfield SF2 is a selective initializing operation for causing an initializing discharge selectively in the discharge cells having undergone an address operation in the address period of the immediately preceding subfield, i.e. in the discharge cells having undergone a sustain discharge in the sustain period of the immediately preceding subfield.

In this manner, the initializing operation in the initializing period of subfield SF2, i.e. a selective initializing operation, is completed.

In the address period of subfield SF2, an address operation is performed so as to apply the driving voltage waveform similar to that in the address period of subfield SF1 to the respective electrodes and accumulate the wall voltage on the respective electrodes of the discharge cells to be lit.

In the subsequent sustain period, similarly to the sustain period of subfield SF1, sustain pulses corresponding in number to the luminance weight are applied alternately to scan electrode SC1-scan electrode SCn and sustain electrode SU1-sustain electrode SUn so as to cause a sustain discharge in the discharge cells having undergone an address discharge in the address period.

In the initializing periods and address periods of subfield SF3-subfield SF5, driving voltage waveforms similar to those in the initializing period and address period of subfield SF2 are applied to the respective electrodes. In the sustain periods of subfield SF3-subfield SF5, driving voltage waveforms similar to those in subfield SF2 except for the number of sustain pulses generated in the sustain period are applied to the respective electrodes.

The above description has outlined the driving voltage waveforms applied to the respective electrodes of panel 10 in this exemplary embodiment.

In this exemplary embodiment, the values of voltage applied to the respective electrodes are set as follows: voltage Vi1=145 (V); voltage Vi2=335 (V); voltage Vi3=190 (V); voltage Vi4=−160 (V); voltage Va=−180 (V); voltage Vc=−35 (V); voltage Vs=190 (V); voltage Vr=190 (V); voltage Ve1=125 (V); voltage Ve2=130 (V); and voltage Vd=60 (V).

In this exemplary embodiment, in the initializing period of subfield SF1, the gradient of the up-ramp waveform voltage applied to scan electrode SC1-scan electrode SCn is set to 1.5 (V/μsec) and the gradient of the down-ramp waveform voltage is set to −2.5 (V/μsec). The gradient of the down-ramp waveform voltage applied to scan electrode SC1-scan electrode SCn in the initializing periods of subfield SF2-subfield SF5 is set to −2.5 (V/μsec).

The specific numerical values, such as the above voltage values and the gradients, are only examples. In the present invention, the respective voltage values or gradients are not limited to the above numerical values. Preferably, the respective voltage values, gradients, or the like are set optimally for the discharge characteristic of the panel and the specifications of the plasma display apparatus, for example.

Next, a description is provided for a subfield structure of one field period in driving the plasma display apparatus and the control of pair of shutter glasses 50 in this exemplary embodiment.

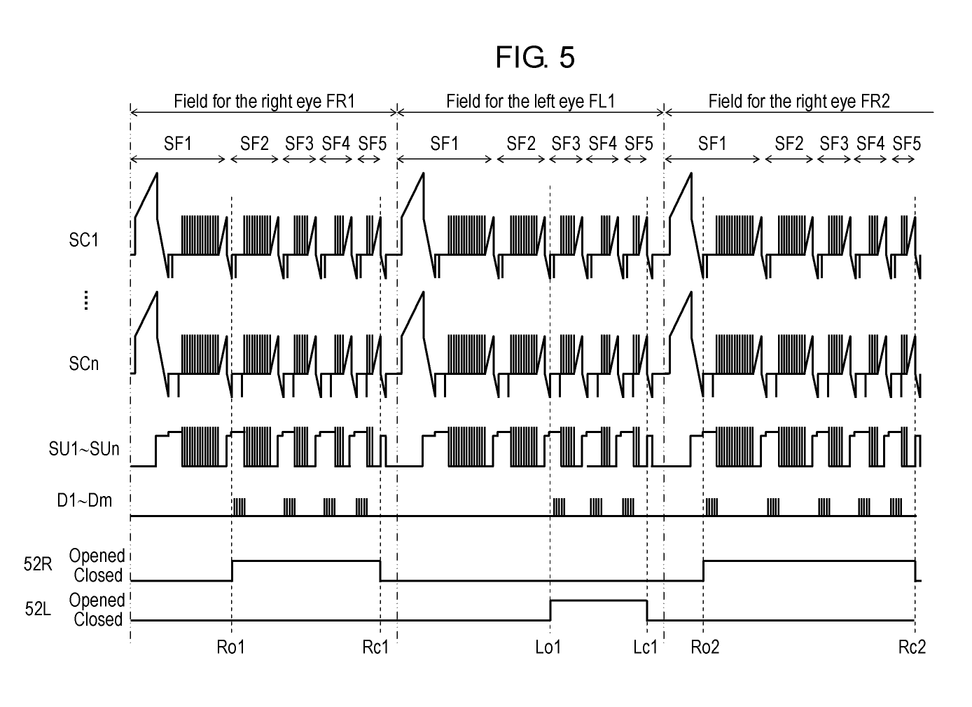

FIG. 5 is a diagram schematically showing a subfield structure in plasma display apparatus 40, and an example of opening/closing control of pair of shutter glasses 50 in accordance with the first exemplary embodiment of the present invention.

FIG. 5 shows driving voltage waveforms applied to the following electrodes: scan electrode SC1 for undergoing an address operation first in the address periods; scan electrode SCn for undergoing an address operation last in the address periods; sustain electrode SU1-sustain electrode SUn; and data electrode D1-data electrode Dm. FIG. 5 also shows opening/closing operations of right eye shutter 52R and left eye shutter 52L. FIG. 5 shows three fields.

In this exemplary embodiment, in order to display a 3D image on panel 10, a field for the right eye and a field for the left eye are alternately generated. For example, among three fields shown in FIG. 5, the first field is field for the right eye FR1, where an image signal for the right eye is displayed on panel 10. The second field is field for the left eye FL1, where an image signal for the left eye is displayed on panel 10. The third field is field for the right eye FR2, where an image signal for the right eye is displayed on panel 10.

FIG. 5 shows an example of the following case. In field for the right eye FR1, no address operation is performed in subfield SF1, and an address operation is performed in subfield SF2-subfield SF5. In field for the left eye FL1, no address operation is performed in subfield SF1 and subfield SF2, and an address operation is performed in subfield SF3-subfield SF5. In field for the right eye FR2, an address operation is performed in subfield SF1-subfield SF5.

The user who views a 3D image displayed on panel 10 through pair of shutter glasses 50 perceives images displayed in two fields (an image for the right eye and an image for the left eye) as one 3D image. Thus, the user perceives the number of images displayed on panel 10 per second as a half the number of fields displayed per second. For instance, when the field frequency (the number of fields generated per second) of 3D images displayed on the panel is 60 Hz, the user perceives thirty 3D images per second. Therefore, in order to display sixty 3D images per second, the field frequency needs to be set to 120 Hz, which is twice of 60 Hz. Then, in this exemplary embodiment, the field frequency (the number of fields generated per second) is set to twice (e.g. 120 Hz) the general field frequency such that the user can view 3D moving images smoothly.

Each of fields for the right eye and fields for the left eye has five subfields (subfield SF1, subfield SF2, subfield SF3, subfield SF4, and subfield SF5). Subfield SF1-subfield SF5 have respective luminance weights of 16, 8, 4, 2, and 1.

In this manner, in this exemplary embodiment, one field is formed of five subfields such that the respective subfields have luminance weights sequentially decreasing in the generation order of the subfields. That is, a subfield having the heaviest luminance weight is generated first in a field, a subfield having the second heaviest luminance weight is generated second, a subfield having the third heaviest luminance weight is generated third, a subfield having the fourth heaviest luminance weight is generated fourth, and a subfield having the lightest luminance weight is generated last in the field.

In this exemplary embodiment, panel 10 is driven by generating the respective subfields in this manner for the following reason.

Phosphor layers 35 for use in panel 10 have afterglow characteristics depending on the materials making up the phosphors. This afterglow is a phenomenon such that the phosphor maintains light emission even after the completion of discharge. The intensity of the afterglow is proportional to the luminance when the phosphor emits light. When the phosphor emits light at a higher luminance, the afterglow is more intense. The afterglow attenuates with a time constant corresponding to the characteristic of the phosphor. With a lapse of time, the luminance gradually decreases. For example, however, there is a phosphor material that has a characteristic of persistence of afterglow for several milliseconds even after the completion of a sustain discharge. When the phosphor emits light at a higher luminance, the time taken for attenuation is longer.

The light emission in a subfield having a heavy luminance weight causes a luminance higher than that of the light emission in a subfield having a light luminance weight. Therefore, the afterglow caused by the light emission in a subfield having a heavy luminance weight has a higher luminance and takes a longer attenuation time than the afterglow caused by the light emission in a subfield having a light luminance weight.

For this reason, when the last subfield of one field is a subfield having a heavy luminance weight, the afterglow leaking into the succeeding field is more intense than that when the last subfield is a subfield having a light luminance weight.

In plasma display apparatus 40 for displaying a 3D image on panel 10 by alternately generating a field for the right eye and a field for the left eye, when the afterglow generated in one field leaks into the succeeding field, the afterglow is perceived by the user as unnecessary light emission unrelated to the image signal. This phenomenon is crosstalk.

Therefore, as the afterglow leaking from one field into the next field increases, the crosstalk increases. This inhibits the stereoscopic view of a 3D image and degrades the image display quality in plasma display apparatus 40. This image display quality is the image display quality for the user who views a 3D image through pair of shutter glasses 50.

In order to reduce the afterglow leaking from one field into the next field and reduce the crosstalk, it is preferable to generate a subfield having a heavy luminance weight at an earlier time of one field such that the intense afterglow is settled in that field.

That is, preferably, a subfield having the heaviest luminance weight is generated first in a field, subfields thereafter have luminance weights sequentially decreasing in the generation order of the subfields, and the last subfield in the field has the lightest luminance weight such that the leak of afterglow into the next field is minimized.

Then, in this exemplary embodiment, in order to suppress crosstalk, subfield SF1 is a subfield having the heaviest luminance weight and subfields thereafter have luminance weights sequentially decreasing.

Next, a description is provided for the control of pair of shutter glasses 50. Based on ON/OFF of the shutter control signal output from control signal output part 46 and received by pair of shutter glasses 50, the opening/closing operation of right eye shutter 52R and left eye shutter 52L of pair of shutter glasses 50 is controlled in the following manner.

Right eye shutter 52R of pair of shutter glasses 50 opens before the sustain period of the subfield where an address operation is performed first in a field for the right eye, and closes before the start of the next field for the left eye. Left eye shutter 52L opens before the sustain period of the subfield where an address operation is performed first in a field for the left eye, and closes before the start of the next field for the right eye.

Hereinafter, based on an example in the address operation shown in FIG. 5, a specific description is provided for the control of pair of shutter glasses 50.

In the example of image signals shown in FIG. 5, no address operation is performed in subfield SF1, and an address operation is performed in subfield SF2-subfield SF5 in field for the right eye FR1. Thus, the subfield where an address operation is performed first in field for the right eye FR1 is subfield SF2. Then, in pair of shutter glasses 50 of this exemplary embodiment, right eye shutter 52R opens in synchronization with start time Ro1 of the address period of subfield SF2, and right eye shutter 52R closes in synchronization with end time Rc1 of the sustain period of subfield SF5 in field for the right eye FR1.

No address operation is performed in subfield SF1 and subfield SF2, and an address operation is performed in subfield SF3-subfield SF5 in field for the left eye FL1. Thus, the subfield where an address operation is performed first in field for the left eye FL1 is subfield SF3. Then, in pair of shutter glasses 50 of this exemplary embodiment, left eye shutter 52L opens in synchronization with start time Lo1 of the address period of subfield SF3, and left eye shutter 52L closes in synchronization with end time Lc1 of the sustain period of subfield SF5 in field for the left eye FL1.

An address operation is performed in subfield SF1-subfield SF5 in field for the right eye FR2. Thus, the subfield where an address operation is performed first in field for the right eye FR2 is subfield SF1. Then, in pair of shutter glasses 50 of this exemplary embodiment, right eye shutter 52R opens in synchronization with start time Ro2 of the address period of subfield SF1, and right eye shutter 52R closes in synchronization with end time Rc2 of the sustain period of subfield SF5 in field for the right eye FR2.

In this manner, in this exemplary embodiment, in each of fields for the right eye and fields for the left eye, the shutter corresponding to the field opens in synchronization with the start time of the address period of the subfield where an address operation is performed first in the field.

In pair of shutter glasses 50, the time that corresponds to the characteristics of the materials (e.g. liquid crystal) making up each shutter is taken for the shutter to start closing and completely close or for the shutter to start opening and completely open. With a pair of shutter glasses that includes shutters made of liquid crystal, it takes approximately 0.5 msec for each shutter to start closing and completely close. It takes approximately 2 msec for the shutter to start opening and completely open.

In this exemplary embodiment, opening/closing operation of each shutter is controlled in consideration of the time taken for the shutter to start closing and completely close and the time taken for the shutter to start opening and completely open.

Hereinafter, a description is provided using a transmittance of the shutter. The transmittance represents the rate of transmittance of visible light with a percentage in the following manner: when the shutter is completely opened, the transmittance is 100% (maximum transmittance), and when the shutter is completely closed, the transmittance is 0% (minimum transmittance).

When the shutter opens, the timing at which the shutter opens is set in the following manner. When a light emission is caused by a sustain discharge in a subfield where an address operation is performed first in each field, the shutter corresponding to the field transmits the light emission. That is, in this exemplary embodiment, the shutter opening timing is set such that immediately before the start of the sustain period of the subfield where an address operation is performed first in each field, the shutter corresponding to the field opens.

The above description of “the shutter opens” is not limited to a transmittance of 100%. In this exemplary embodiment, the shutter opening timing is set such that the transmittance of the shutter corresponding to the field is equal to or higher than 70%, preferably 90%, immediately before the start of the sustain period of a subfield where an address operation is performed first in each field.

In the above example, a description is provided on the following condition. In synchronization with the start time of the address period of the subfield where an address operation is performed first in each field, the shutter corresponding to the field starts to open. Thereby, before the start of the sustain period of the subfield, the shutter corresponding to the field opens.

When the shutter closes, the shutter closing timing is set such that after the sustain period of the last subfield (subfield SF5 in this exemplary embodiment) in each field has been completed, the shutter corresponding to the field starts to close and the transmittance of the shutter is equal to or lower than 30%, preferably 10%, immediately before the start of the next field.

As described above, in this exemplary embodiment, in each field, the timing at which the shutter corresponding to the field opens is set such that the shutter corresponding to the field opens immediately before the sustain period of the subfield where an address operation is performed first in the field.

Therefore, in this exemplary embodiment, in each of fields for the right eye and fields for the left eye, before the sustain period of the subfield where an address operation is performed first in each field, the shutter corresponding to the field opens, and the shutter closes before the start of the next field.

Controlling pair of shutter glasses 50 in this manner can suppress crosstalk occurring in a 3D image and provide a high-quality 3D image to the user who views the 3D image displayed on panel 10 through pair of shutter glasses 50. Hereinafter, the reason is described.

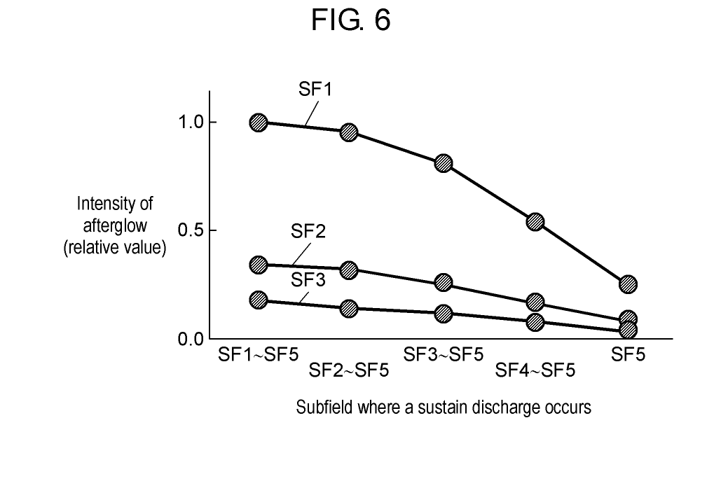

FIG. 6 is a graph schematically showing an intensity of afterglow in a target field when a sustain discharge is caused in a field immediately preceding the target field. The graph of FIG. 6 shows a result of an experiment conducted when one field is formed of five subfields, i.e. subfield SF1-subfield SF5, and subfield SF1-subfield SF5 have respective luminance weights of 16, 8, 4, 2, and 1.

In FIG. 6, the horizontal axis shows a subfield where a sustain discharge has occurred in a field immediately preceding the target field. The vertical axis shows an intensity of afterglow with a relative value. For example, “SF1-SF5” of FIG. 6 show that a sustain discharge has occurred in each of subfield SF1 through subfield SF5. Thus, in the direction of the vertical axis, the intensity of afterglow in display of gradation “31” is shown. “SF2-SF5” show that a sustain discharge has occurred in each of subfield SF2 through subfield SF5. Thus, in the direction of the vertical axis, the intensity of afterglow in display of gradation “15” is shown. “SF3-SF5” show that a sustain discharge has occurred in each of subfield SF3 through subfield SF5. Thus, in the direction of the vertical axis, the intensity of afterglow in display of gradation “7” is shown. “SF4-SF5” show that a sustain discharge has occurred in subfield SF4 and subfield SF5. Thus, in the direction of the vertical axis, the intensity of afterglow in display of gradation “3” is shown. “SF5” shows that a sustain discharge has occurred only in subfield SF5. Thus, in the direction of the vertical axis, the intensity of afterglow in display of gradation “1” is shown.

The value shown by “SF1” in FIG. 6 represents the intensity of afterglow at the start of the address period of subfield SF1 in the target field. The value shown by “SF2” represents the intensity of afterglow at the start of the address period of subfield SF2 in the target field. The value shown by “SF3” represents the intensity of afterglow at the start of the address period of subfield SF3 in the target field.

As shown in FIG. 6, when the number of subfields where a sustain discharge occurs in a field immediately preceding the target field is greater, the afterglow in the target field is more intense. For example, in the case of “SF1-SF5”, the intensity of afterglow at the start of the address period of subfield SF1 in the target field is approximately twice the intensity in the case of “SF4-SF5”. In this manner, as the period during which a sustain discharge occurs in the field immediately preceding the target field increases, that is, a higher gradation is displayed, the afterglow in the target field becomes more intense.

In contrast, in the case of “SF1-SF5”, the intensity of afterglow at the start of the address period of subfield SF1 is approximately three times the intensity of afterglow at the start of the address period of subfield SF2, and approximately five times the intensity of afterglow at the start of the address period of subfield SF3. This shows that the afterglow rapidly attenuates. Therefore, even if intense afterglow is perceived in the address period of subfield SF1, the afterglow becomes weak in the address period of subfield SF2, and weaker in the address period of subfield SF3, thus exerting substantially no effect as an after image.

The afterimage phenomenon occurs more remarkably when the afterglow is more intense. When the display gradation in the target field is lower, the afterimage is perceived by the user more clearly.

In this exemplary embodiment, a subfield having the heaviest luminance weight is generated first in a field, subfields thereafter have luminance weights sequentially decreasing in the generation order of the subfields, and the last subfield in the field has the lightest luminance weight. Thus, when the gradation displayed on the panel is dark, in response to the gradation, no light emission occurs in subfield SF1 and subfield SF2 having relatively heavy luminance weights, which occur relatively earlier in the field.

In this exemplary embodiment, in a field where no address operation is performed in subfield SF1, for example, the shutter of pair of shutter glasses 50 corresponding to the field does not open at least until the completion of subfield SF1. Alternatively, in a field where no address operation is performed in subfield SF1 and subfield SF2, the shutter of pair of shutter glasses 50 corresponding to the field does not open at least until the completion of subfield SF2. In this manner, in a field for display of a dark gradation with a remarkable afterimage, the timing at which the shutter corresponding to the field opens is later than that in a field for display of a bright gradation with an unremarkable afterimage.

The afterglow while the shutter is closed is not perceived by the user. Therefore, when the shutter opening timing is later, the afterglow entering the eye of the user is less than that when the shutter opening timing is earlier. When the shutter opening timing is later, the afterglow weakens during that period. Thus, the afterglow entering the eye of the user when the shutter opens is reduced by that amount.

In this manner, in this exemplary embodiment, in a field for display of a dark gradation with a remarkable afterimage, the timing at which the shutter corresponding to the field opens can be made later than that in a field for display of a bright gradation. Thus, during that period, the afterglow weakens. This can suppress the crosstalk and provide a high-quality 3D image to the user who views a 3D image through pair of shutter glasses 50.

In this exemplary embodiment, a forced initializing operation is performed in the initializing period of subfield SF1 occurring first in a field. This can cause an initializing discharge in all the discharge cells in panel 10 at least once in a field, thus stabilizing the address operation. At this time, a light emission is caused by the forced initializing operation. However, in this exemplary embodiment, in any of fields for the right eye and fields for the left eye, both of right eye shutter 52R and left eye shutter 52L are closed in the period during which the forced initializing operation is performed.

With this operation, in a plasma display system of this exemplary embodiment, the light emission generated by the forced initializing operation is blocked by right eye shutter 52R and left eye shutter 52L, and does not enter the eyes of the user. That is, the user who views a 3D image through pair of shutter glasses 50 does not perceive the light emission caused by the forced initializing operation. Thus, the luminance of black level is reduced by the luminance caused by that light emission. This enables the user to view an image of high contrast with reduced luminance of black level.

Timing generation circuit 45 generates timing signals such that control signal output part 46 outputs shutter control signals for enabling right eye shutter 52R and left eye shutter 52L to perform the above opening/closing operations of the shutters. The timing generation circuit supplies the timing signals to control signal output part 46.

### Second Exemplary Embodiment

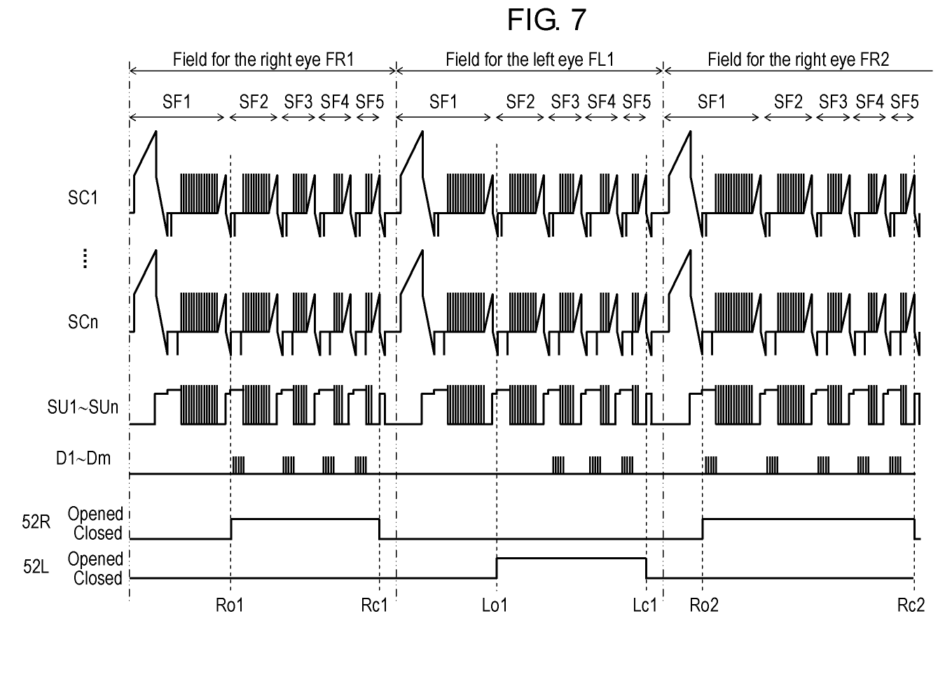

FIG. 7 is a diagram schematically showing a subfield structure in the plasma display apparatus, and an example of opening/closing control of pair of shutter glasses 50 in accordance with the second exemplary embodiment of the present invention.

Similarly to FIG. 5, FIG. 7 shows driving voltage waveforms applied to the following electrodes: scan electrode SC1 for undergoing an address operation first in the address periods; scan electrode SCn for undergoing an address operation last in the address periods; sustain electrode SU1-sustain electrode SUn; and data electrode D1-data electrode Dm. FIG. 7 also shows opening/closing operations of right eye shutter 52R and left eye shutter 52L.

In this exemplary embodiment, similarly to the example shown in FIG. 5, the field frequency is set to twice (e.g. 120 Hz) the general field frequency. Each of fields for the right eye and fields for the left eye has five subfields (subfield SF1, subfield SF2, subfield SF3, subfield SF4, and subfield SF5). Subfield SF1-subfield SF5 have respective luminance weights of 16, 8, 4, 2, and 1.

FIG. 7 shows three fields as an example. Among the three fields shown in FIG. 7, the first field is field for the right eye FR1, where an image signal for the right eye is displayed on panel 10. The second field is field for the left eye FL1, where an image signal for the left eye is displayed on panel 10. The third field is field for the right eye FR2, where an image signal for the right eye is displayed on panel 10.

FIG. 7 shows an example of the following case. No address operation is performed in subfield SF1, and an address operation is performed in subfield SF2-subfield SF5 in field for the right eye FR1. No address operation is performed in subfield SF1 and subfield SF2, and an address operation is performed in subfield SF3-subfield SF5 in field for the left eye FL1. An address operation is performed in subfield SF1-subfield SF5 in field for the right eye FR2.

In the example of image signals shown in FIG. 7, no address operation is performed in subfield SF1, and an address operation is performed in subfield SF2-subfield SF5 in field for the right eye FR1. Thus, the subfield where an address operation is performed first in field for the right eye FR1 is subfield SF2. Then, in pair of shutter glasses 50 of this exemplary embodiment, similarly to the operation shown in the first exemplary embodiment, right eye shutter 52R opens in synchronization with start time Ro1 of the address period of subfield SF2, and right eye shutter 52R closes in synchronization with end time Rc1 of the sustain period of subfield SF5, in field for the right eye FR1.

No address operation is performed in subfield SF1 and subfield SF2, and an address operation is performed in subfield SF3-subfield SF5 in field for the left eye FL1. Thus, the subfield where an address operation is performed first in field for the left eye FL1 is subfield SF3. Then, in pair of shutter glasses 50 of this exemplary embodiment, differently from the operation shown in the first exemplary embodiment, left eye shutter 52L opens in synchronization with start time Lo1 of the address period of subfield SF2, and left eye shutter 52L closes in synchronization with end time Lc1 of the sustain period of subfield SF5, in field for the left eye L1.

An address operation is performed in subfield SF1-subfield SF5 in field for the right eye FR2. Thus, the subfield where an address operation is performed first in field for the right eye FR2 is subfield SF1. Then, in pair of shutter glasses 50 of this exemplary embodiment, similarly to the operation shown in the first exemplary embodiment, right eye shutter 52R opens in synchronization with start time Ro2 of the address period of subfield SF1, and right eye shutter 52R closes in synchronization with end time Rc2 of the sustain period of subfield SF5 in field for the right eye FR2.

In this manner, in the second exemplary embodiment, only the address operation in subfield SF1 occurring first in a field is focused. When an address operation is performed in subfield SF1 in each field, the shutter corresponding to the field opens in synchronization with the start time of the address period of subfield SF1. When no address operation is performed in subfield SF1, the shutter corresponding to the field opens in synchronization with the start time of the address period of subfield SF2.

When the shutter opens, similarly to the first exemplary embodiment, the operation of opening the shutter is controlled in consideration of the time taken for the shutter to start opening and completely open.

The operation of closing the shutter is similar to the operation in the first exemplary embodiment, and thus the description thereof is omitted.

As shown in FIG. 6 of the first exemplary embodiment, the afterglow rapidly attenuates with a lapse of time. Therefore, as described above, only the address operation in subfield SF1 occurring first in a field is focused, and in a field where no address operation is performed in subfield SF1, the timing at which the shutter corresponding to the field opens is delayed until the completion of subfield SF1. Such an operation can suppress crosstalk to a level at which no practical problem arises.

In this exemplary embodiment of the present invention, when the light emission caused by the address discharge is used for display of gradations, it is preferable to open the shutter in synchronization with the start time of the address period. However, when the light emission caused by the address discharge is not used for display of gradations, the operation of opening/closing the shutter is controlled such that the shutter opens immediately before the start of the sustain period.

In the examples described in the exemplary embodiments of the present invention, in synchronization with the end time of the sustain period of the subfield occurring last in a field, the shutter corresponding to the field closes. However, the timing at which the shutter closes may be the timing after the completion of the image display in the current field and before the start of the image display in the next field. Therefore, for instance, the shutter may close immediately after the last sustain discharge in the sustain period of the last subfield in the current field. Alternatively, the shutter may close immediately before the first subfield in the next field.

In the exemplary embodiments of the present invention, FIG. 5 and FIG. 7 show diagrams where there is no temporal delay in the opening/closing control of the shutters and the opening/closing is switched in an instant. However, as described in the first exemplary embodiment, the time corresponding to the materials making up the shutter is taken to switch the opening/closing of the shutter. Therefore, in the plasma display apparatus shown in the exemplary embodiments of the present invention, the timing of the shutter control signal is set in consideration of such time.

FIG. 5 and FIG. 7 show examples where a down-ramp waveform voltage is generated and applied to scan electrode SC1-scan electrode SCn and voltage Ve 1 is applied to sustain electrode KU-sustain electrode SUn in the period after the completion of subfield SF5 and before the start of subfield SF1. However, these voltages do not need to be generated necessarily. For example, in the period after the completion of subfield SF5 and before the start of subfield SF1, scan electrode SC1-scan electrode SCn, sustain electrode SU1-sustain electrode SUn, and data electrode D1-data electrode Dm may be kept at 0 (V).

In the examples described in the exemplary embodiments of the present invention, one field is formed of five subfields. However, in the present invention, the number of subfields forming one field is not limited to the above number. For example, setting the number of subfields greater than five can increase the number of gradations displayable on panel 10.

In the examples described in the exemplary embodiments of the present invention, the luminance weights of the subfields are powers of “2”, that is, the respective luminance weights of subfield SF1-subfield SF5 are set to 16, 8, 4, 2 and 1. However, the luminance weights set to the respective subfields are not limited to the above numerical values. Setting the luminance weights to 12, 7, 3, 2 and 1, for example, gives redundancy to the combination of the subfields determining gradations and allows the coding with which the occurrence of a moving image false contour is suppressed. The number of subfields forming one field, the luminance weights of the respective subfields, or the like is set appropriately for the characteristics of panel 10 and the specifications of plasma display apparatus 40, for example.

Each circuit block shown in the exemplary embodiments of the present invention may be formed as an electric circuit that performs each operation shown in the exemplary embodiments, or formed of a microcomputer, for example, programmed so as to perform the similar operations. In the examples described in the exemplary embodiments, one pixel is formed of discharge cells of R, G, and B three colors. Also a panel that includes pixels, each formed of discharge cells of four or more colors, can use the configuration shown in the exemplary embodiments and provide the same advantages.

The above driver circuit only shows an example and the configuration of the driver circuit is not limited to the above configuration.

The specific numerical values shown in the exemplary embodiments of the present invention are set based on the characteristics of panel 10 that has a 50-inch screen and 1024 display electrode pairs 24, and only show examples in the exemplary embodiments. The present invention is not limited to these numerical values. Preferably, each numerical value is set optimally for the characteristics of the panel, the specifications of the plasma display apparatus, or the like. Variations are allowed for each numerical value within the range in which the above advantages can be obtained. The number of subfields forming one field, the luminance weights of the respective subfields, or the like is not limited to the values shown in the exemplary embodiments of the present invention. The subfield structure may be switched based on image signals, for example.

### INDUSTRIAL APPLICABILITY

The present invention can enhance the image display quality by reducing crosstalk to the user who views a 3D image displayed on the panel through a pair of shutter glasses, in a plasma display apparatus usable as a 3D image display apparatus. Thus, the present invention is useful as a plasma display apparatus and a plasma display system.

### REFERENCE MARKS IN THE DRAWINGS

10 Panel
21 Front substrate
22 Scan electrode
23 Sustain electrode
24 Display electrode pair
25, 33 Dielectric layer
26 Protective layer
31 Rear substrate
32 Data electrode
34 Barrier rib
35 Phosphor layer
40 Plasma display apparatus
41 Image signal processing circuit
42 Data electrode driver circuit
43 Scan electrode driver circuit
44 Sustain electrode driver circuit
45 Timing generation circuit
46 Control signal output part
50 Pair of shutter glasses
52R Right eye shutter
52L Left eye shutter

1. A plasma display system comprising:
a plasma display apparatus including:
a plasma display panel having a plurality of discharge cells arranged therein; and
a driver circuit for driving the plasma display panel, the driver circuit displaying an image on the plasma display panel by alternately repeating a field for a right eye and a field for a left eye, an image signal for the right eye being displayed in the field for the right eye, an image signal for the left eye being displayed in the field for the left eye; and
a pair of shutter glasses including a right eye shutter for opening and closing in the field for the right eye, and a left eye shutter for opening and closing in the field for the left eye,
wherein, in the plasma display apparatus, each of the field for the right eye and the field for the left eye is formed of a plurality of subfields, each of the subfields has a predetermined luminance weight, and the luminance weights of the respective subfields are set such that the first subfield of the one field has a largest luminance weight, and the subfields thereafter have luminance weights sequentially decreasing, and
the pair of shutter glasses is controlled in a manner such that
the right eye shutter opens before a sustain period of the subfield where an address operation is performed first in the field for the right eye, and closes before the field for the left eye next to the field for the right eye, and
the left eye shutter opens before a sustain period of the subfield where an address operation is performed first in the field for the left eye, and closes before the field for the right eye next to the field for the left eye.

2. A plasma display system comprising:
a plasma display apparatus including:
a plasma display panel having a plurality of discharge cells arranged therein; and
a driver circuit for driving the plasma display panel, the driver circuit displaying an image on the plasma display panel by alternately repeating a field for a right eye and a field for a left eye, an image signal for the right eye being displayed in the field for the right eye, an image signal for the left eye being displayed in the field for the left eye; and
a pair of shutter glasses including a right eye shutter for opening and closing in the field for the right eye, and a left eye shutter for opening and closing in the field for the left eye,
wherein, in the plasma display apparatus, each of the field for the right eye and the field for the left eye is formed of a plurality of subfields, each of the subfields has a predetermined luminance weight, and the luminance weights of the respective subfields are set such that the first subfield of the one field has a largest luminance weight, and the subfields thereafter have luminance weights sequentially decreasing, and
the pair of shutter glasses is controlled in a manner such that
when the right eye shutter opens in the field for the right eye and an address operation is performed in the first subfield of the one field, the right eye shutter opens before a sustain period of the first subfield,
when the right eye shutter opens in the field for the right eye and an address operation is not performed in the first subfield of the one field, the right eye shutter opens before a sustain period of the subfield next to the first subfield,
when the right eye shutter closes, the right eye shutter closes before the field for the left eye next to the field for the right eye,
when the left eye shutter opens in the field for the left eye and an address operation is performed in the first subfield of the one field, the left eye shutter opens before a sustain period of the first subfield,
when the left eye shutter opens in the field for the left eye and an address operation is not performed in the first subfield of the one field, the left eye shutter opens before a sustain period of the subfield next to the first subfield, and
when the left eye shutter closes, the left eye shutter closes before the field for the right eye next to the field for the left eye.

3. A plasma display apparatus comprising:
a plasma display panel having a plurality of discharge cells arranged therein; and
a driver circuit for driving the plasma display panel, the driver circuit displaying an image on the plasma display panel by alternately repeating a field for a right eye and a field for a left eye, an image signal for the right eye being displayed in the field for the right eye, an image signal for the left eye being displayed in the field for the left eye,
wherein, in the driver circuit, each of the field for the right eye and the field for the left eye is formed of a plurality of subfields, each of the subfields has a predetermined luminance weight, the luminance weights of the respective subfields are set such that the first subfield of the one field has a largest luminance weight, and the subfields thereafter have luminance weights sequentially decreasing, and
the driver circuit generates a control signal to a pair of shutter glasses including a right eye shutter and a left eye shutter in a manner such that
the right eye shutter opens before a sustain period of the subfield where an address operation is performed first in the field for the right eye, and closes before the field for the left eye next to the field for the right eye, and
the left eye shutter opens before a sustain period of the subfield where an address operation is performed first in the field for the left eye, and closes before the field for the right eye next to the field for the left eye.

4. A plasma display apparatus comprising:
a plasma display panel having a plurality of discharge cells arranged therein; and
a driver circuit for driving the plasma display panel, the driver circuit displaying an image on the plasma display panel by alternately repeating a field for a right eye and a field for a left eye, an image signal for the right eye being displayed in the field for the right eye, an image signal for the left eye being displayed in the field for the left eye,
wherein the driver circuit sets such that each of the field for the right eye and the field for the left eye is formed of a plurality of subfields, each of the subfields has a predetermined luminance weight, and the luminance weights of the respective subfields are set such that the first subfield of the one field has a largest luminance weight, and the subfields thereafter have luminance weights sequentially decreasing, and
the driver circuit generates a control signal to a pair of shutter glasses including a right eye shutter and a left eye shutter in a manner such that
when the right eye shutter opens in the field for the right eye and an address operation is performed in the first subfield of the one field, the right eye shutter opens before a sustain period of the first subfield,
when the right eye shutter opens in the field for the right eye and an address operation is not performed in the first subfield of the one field, the right eye shutter opens before a sustain period of the subfield next to the first subfield,
when the right eye shutter closes, the right eye shutter closes before the field for the left eye next to the field for the right eye,
when the left eye shutter opens in the field for the left eye and an address operation is performed in the first subfield of the one field, the left eye shutter opens before a sustain period of the first subfield,
when the left eye shutter opens in the field for the left eye and an address operation is not performed in the first subfield of the one field, the left eye shutter opens before a sustain period of the subfield next to the first subfield, and
when the left eye shutter closes, the left eye shutter closes before the field for the right eye next to the field for the left eye.
